(19) United States
(12) Patent Application Publication
(10) Pub. No.: US 2024/0146442 A1
(43) Pub. Date: May 2, 2024

(54) MCS SELECTION IN SBFD

(71) Applicant: MediaTek Singapore Pte. Ltd., Singapore (SG)

(72) Inventors: Sumaila Anning Mahama, Cambridge (GB); Mohammed S Aleabe Al-Imari, Cambridge (GB); Jozsef Gabor Nemeth, Cambridge (GB)

(21) Appl. No.: 18/378,699

(22) Filed: Oct. 11, 2023

Related U.S. Application Data
(60) Provisional application No. 63/380,960, filed on Oct. 26, 2022.

(51) Int. Cl. H04L 1/00; H04W 72/0446; H04W 72/11; H04W 72/12; H04W 72/232

(52) U.S. Cl. CPC H04L 1/0004; H04W 72/0446; H04W 72/11; H04W 72/12; H04W 72/232

(57) ABSTRACT

In an aspect of the disclosure, a method, a computer-readable medium, and an apparatus are provided. The UE receives scheduling of one or more data channels for transmission on a set of slots. The UE determines the set of slots including one or more partitioned slots and one or more non-partitioned slots. The UE receives an indication of a first modulation and coding scheme (MCS) for the non-partitioned slots and an indication of a second MCS for the partitioned slots. The UE transmits a first part of the one or more data channels on the one or more non-partitioned slots according to the first MCS. The UE transmits a second part of the one or more data channels on the one or more partitioned slots according to the second MCS.

### CROSS-REFERENCE TO RELATED APPLICATION(S)

This application claims the benefits of U.S. Provisional Application Ser. No. 63/380,960, entitled “MCS SELECTION IN SBFD” and filed on Oct. 26, 2022, which is expressly incorporated by reference herein in their entirety.

### BACKGROUND

### Field

The present disclosure relates generally to communication systems, and more particularly, to techniques of selecting modulation and coding scheme (MCS) in Single-Band Full Duplex (SBFD) communications.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The UE receives scheduling of one or more data channels for transmission on a set of slots. The UE determines the set of slots including one or more partitioned slots and one or more non-partitioned slots. The UE receives an indication of a first modulation and coding scheme (MCS) for the non-partitioned slots and an indication of a second MCS for the partitioned slots. The UE transmits a first part of the one or more data channels on the one or more non-partitioned slots according to the first MCS. The UE transmits a second part of the one or more data channels on the one or more partitioned slots according to the second MCS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating Single-Band Full Duplex (SBFD) communications between a base station and a UE.

FIG. 8 is a diagram illustrating an exemplary SBFD slot pattern.

FIG. 9 is a flow chart of a method (process) for transmitting one or more data channels according to multiple MC Ss.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

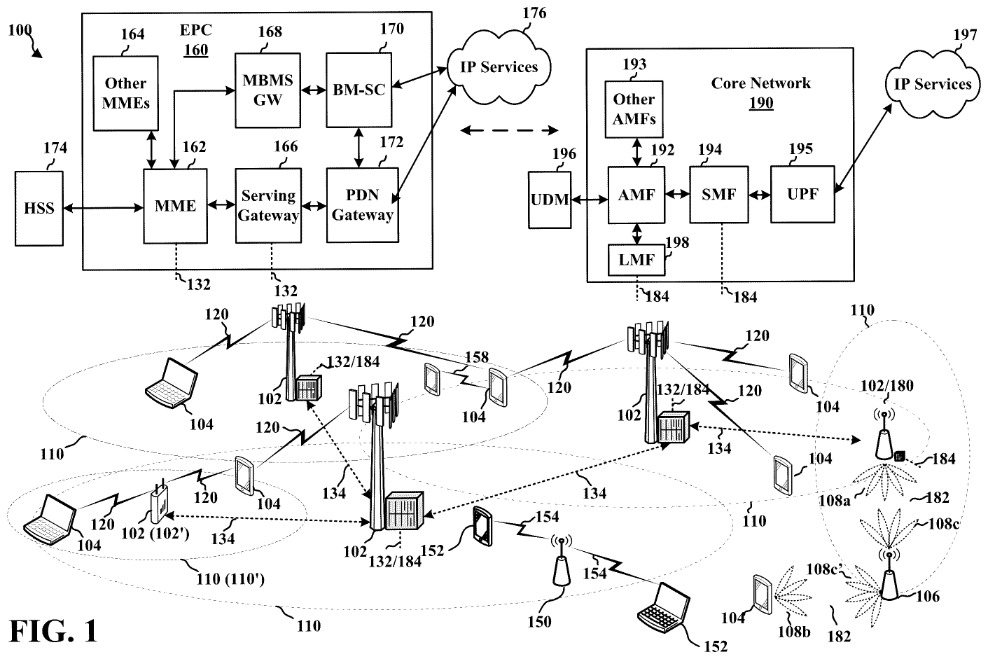

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

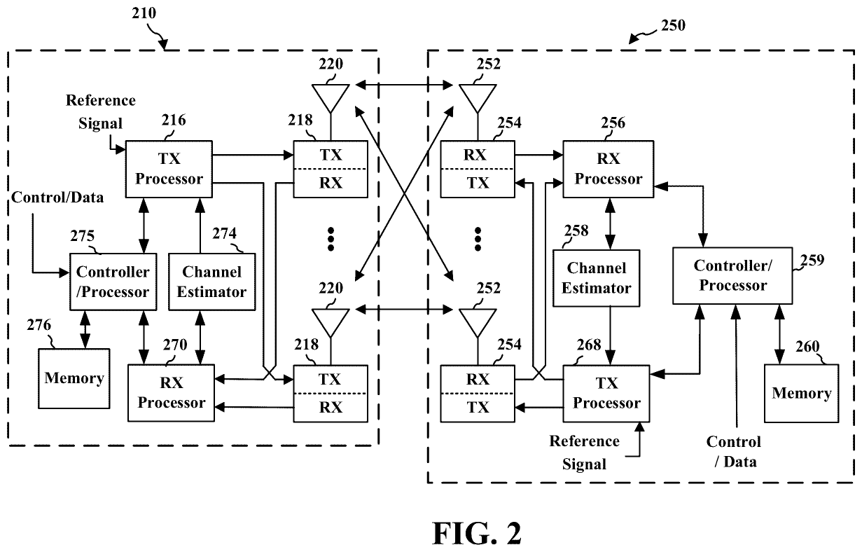

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

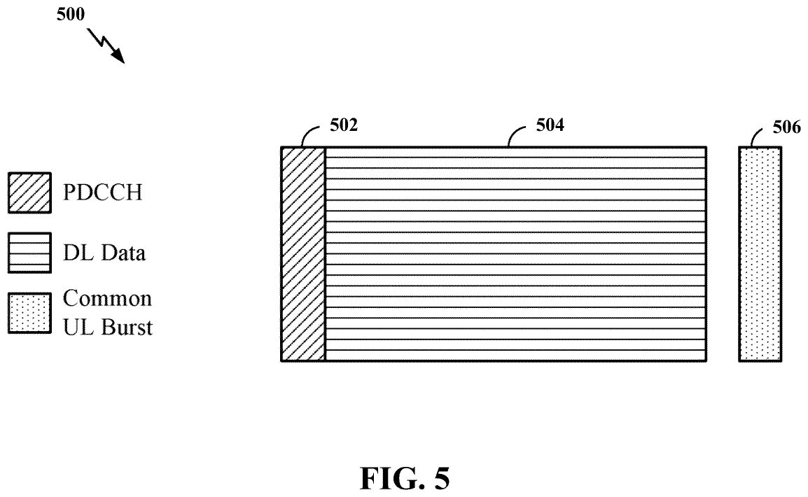

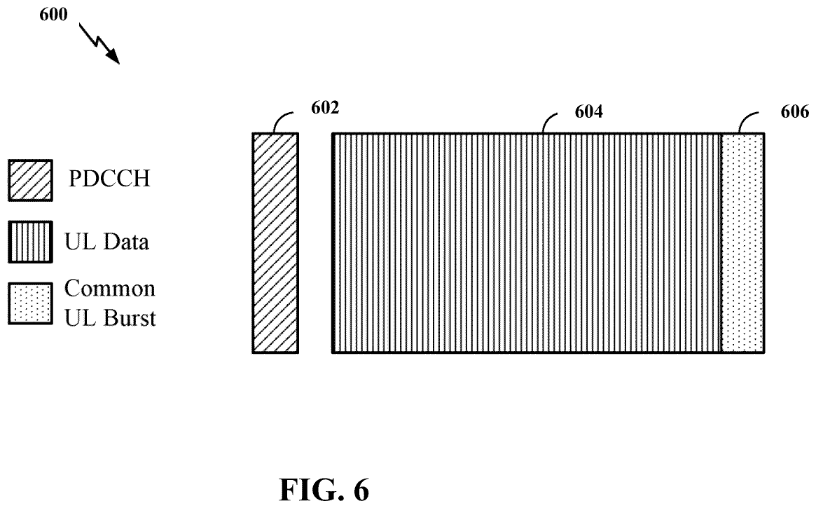

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

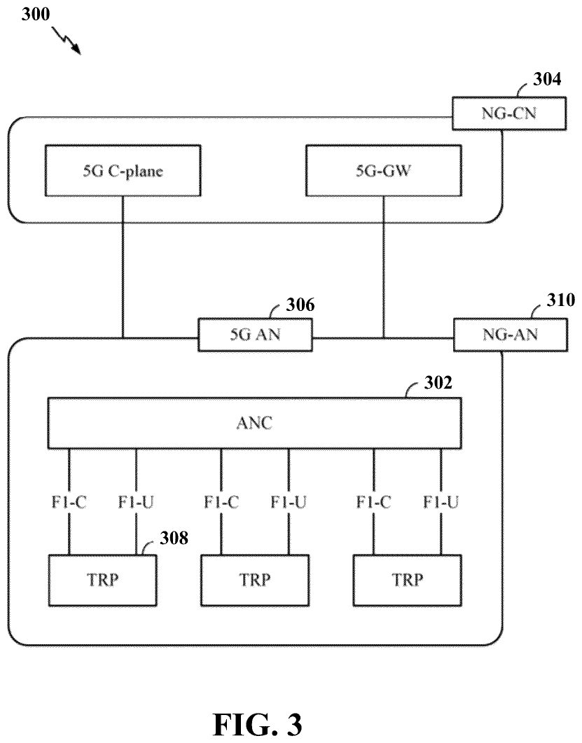

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

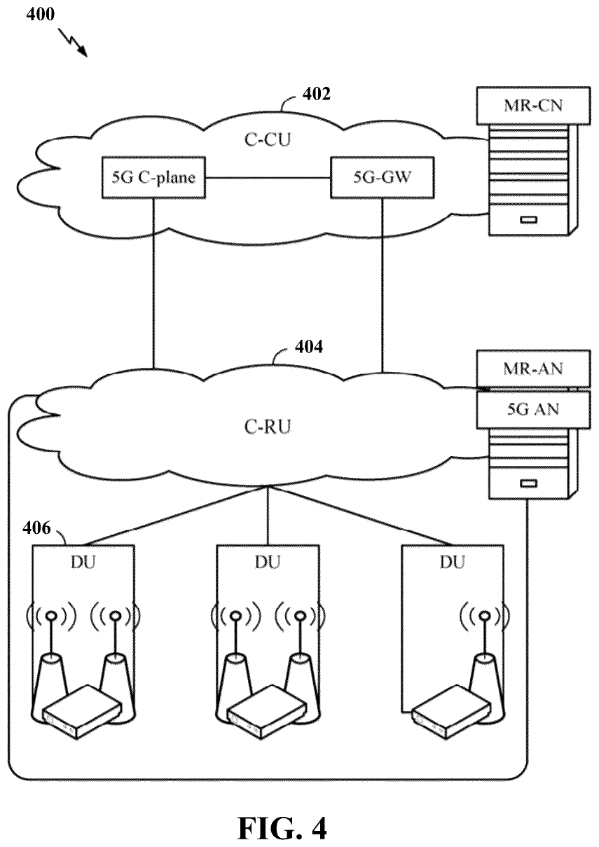

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

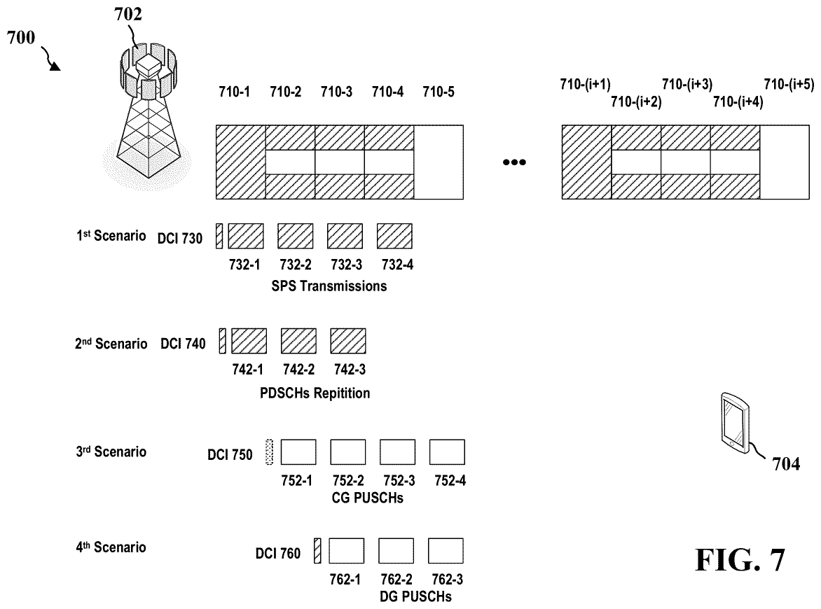

FIG. 7 is a diagram 700 illustrating Single-Band Full Duplex (SBFD) communications between a base station and a UE. In this example, the base station 702 communicates with a UE 704 in accordance with slots 710-1, . . . , 710-N. Further, the base station 702 supports Single-Band Full Duplex (SBFD) communications.

In SBFD, downlink and uplink transmissions occur in the same frequency band but in different time slots or parts of a time slot. In SBFD, a base station can transmit in the downlink portion of a time slot, while receiving uplink transmissions in the uplink portion of the same time slot. This allows more efficient utilization of the frequency band compared to FDD. However, SBFD introduces new interference issues like self-interference at the base station and cross-link interference between uplink and downlink. Special techniques are required to handle this interference and realize the benefits of SBFD.

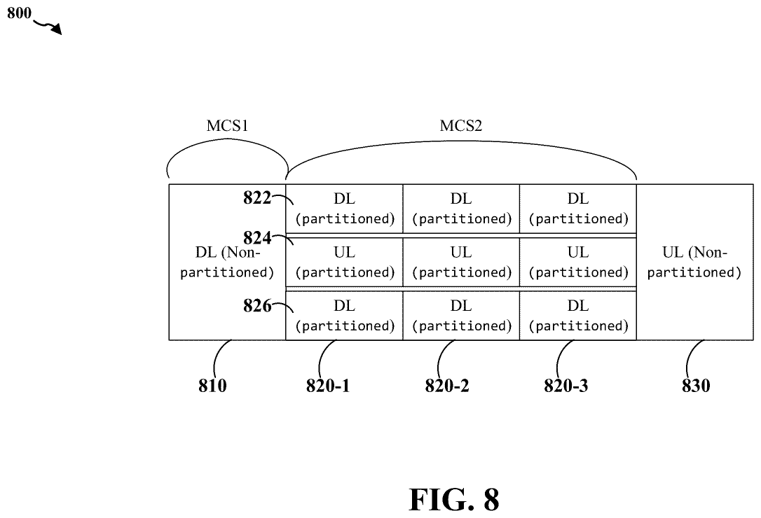

FIG. 8 is a diagram 800 illustrating an exemplary SBFD slot pattern. In this example, the base station 702 may configure the slots 710-1, . . . , 710-N according to a specific SBFD pattern. In particular, the slots 710-1, . . . , 710-N contains one or more groups of 5 consecutive slots, each group including anon-partitioned DL slot 810, partitioned DL/UL slots 820-1, 820-2, 820-3, and a non-partitioned UL slot 830. In the non-partitioned DL slot 810, downlink transmissions occupy the entire frequency bandwidth of the carrier established between the base station 702 and the UE 704. In the non-partitioned UL slot 830, uplink transmissions occupy the entire frequency bandwidth of the carrier. Further, the bandwidth of the carrier in each slot of the partitioned DL/UL slots 820-1, 820-2, 820-3 are divided into a DL portion 822, a UL portion 824, and a DL portion 826 that do not overlap.

The base station 702 configures the UE 704 for uplink and downlink transmissions across multiple slots 710-1, . . . , 710-N. This includes multi-slot transmissions such as semi-persistent scheduling (SPS) in the downlink and uplink, physical downlink shared channel (PDSCH) repetition in the downlink, configured grant (CG) PUSCH transmissions in the uplink, and dynamic grant (CG) PUSCH transmissions in the uplink.

However, with the introduction of single-band full-duplex (SBFD) operation, the slots 710-1, . . . , 710-N can include both partitioned slots and non-partitioned slots. Partitioned slots have a different interference distribution compared to non-partitioned slots.

In the communications system shown in FIG. 7 between the base station 702 and the UE 704, the base station 702 configures the slots 710-1, . . . , 710-N according to a specific SBFD pattern as shown in FIG. 8. This results in that one or more groups of slots in the slots 710-1, . . . , 710-N each are configured according to the partitioned slots 820-1, 820-2, 820-3 and non-partitioned slots 810, 830.

In a first approach, a single MCS is configured for all slots of the multiple slots used for transmissions within the SPS periodicity. For SBFD systems, the single MCS selection may be inefficient because SBFD systems have two slot types with different interference distributions on each slot type potentially requiring different MCSs. In a second approach, as the two slot types in SBFD (partitioned slots and non-partitioned slots) have different interference distributions, configuring separate MCSs for each slot type enables flexible link adaptation based on the interference level on each slot type.

In certain configurations, the base station 702 sends configurations of a MCS table to the UE 704. The MCS table is a table of modulation and coding schemes that is configured by the network for a UE. It contains different combinations of modulation orders (e.g. QPSK, 16QAM, 64QAM) and code rates that can be used for downlink or uplink transmissions. When an MCS table is configured, the network can indicate a particular MCS to use for a transmission through an MCS indication such as an MCS index. An MCS indication points to a specific row in the MCS table which contains the modulation order and code rate to use.

In a first technique, the base station 702 sends MCS indications that indicate multiple MCSs from the MCS table for multiple slot types. For example, a first MCS indication may indicate a first MCS (MCS1) to be applied to non-partitioned slots and a second MCS indication may indicate a second MCS (MCS2) to be applied to partitioned slots. The MCS1 may be a higher order MCS (MCS1) configured for the non-partitioned slot. The MCS2 may be a lower order MCS configured for partitioned slots that may have potential additional cross-link interference. For example, the downlink transmissions in the DL portion 822 and the uplink transmissions in the UL portion 824 may cause interference to each other.

Each MCS may be applied to specific sets of slots. The slot type of a given slot within the SPS periodicity is considered as non-partitioned if the given slot only overlaps with non-partitioned symbols. Otherwise, the slot type is considered as partitioned.

In a second technique, instead of sending a second MCS indication to indicate the second MCS directly, the base station 702 sends a differential MCS indication that indicates the second MCS relative to the first MCS as follows:
differentialMCS=MCS1-MCS2
The second MCS (MCS2) can be derived as:
MCS2=MCS1-differentialMCS

Where differentialMCS is derived from mapping the indicated differentialMCS_Index. In one option, the mapping from differentialMCS_Index to differentialMCS is:

| differentialMCS_Index | differentialMCS |
|---|---|
| 00 | 0 |
| 01 | 1 |
| 10 | 2 |
| 11 | 3 |

In certain configurations, the sets of slots where each MCS is applied are indicated to the UE 704 via high layer parameters. In certain configurations, a bitmap indicates the sets of slots for each MCS. The bitmap may be sent via layer-1 signaling or high layer parameters.

In a first scenario, the base station 702 may use SPS to schedule transmission in multiple slots within a configured SPS periodicity. That is, according to the SPS configurations, in this example, the multi-slot transmissions are scheduled in a group of consecutive slots in each SPS period. For example, the slots 710-1 to 710-5 and the slots 710-(i+1) to 710-(i+5) may be in two separate SPS periods and carry the SPS transmissions. Further, in this example, each group of slots such as the slots 710-1 to 710-5, the slots 710-(i+1) to 710-(i+5), etc. correspond to the non-partitioned DL slot 810, the partitioned DL/UL slot 820-1, the partitioned DL/UL slot 820-2, the partitioned DL/UL slot 820-3, and the non-partitioned UL slot 830.

In particular, in this example, the SPS configurations schedule PDSCHs 732-1, 732-2, 732-3, 732-4 in each set of the slots 710-1 to 710-4, . . . , the slots 710-(i+1) to 710-(i+4), etc. More specifically, using the slots 810, 820-1, 820-2, 820-3, 830 to illustrate each group of 5 consecutive slots (e.g., the slots 710-1 to 710-5, the slots 710-(i+1) to 710-(i+5)) in the slots 710-1, . . . , 710-N, the PDSCHs 732-1, 732-2, 732-3, 732-4 are in the non-partitioned DL slot 810 and the DL portions 822 of the partitioned DL/UL slots 820-1, 820-2, 820-3.

As shown, the slots within the configured SPS periodicity may include partitioned SBFD slots and non-partitioned slots. In this example, the multi-slot transmissions according to the SPS configuration occur on one non-partitioned slot (the non-partitioned DL slot 810) and three partitioned slots (the partitioned DL/UL slots 820-1, 820-2, 820-3). These two slot types have different interference distributions, leading to a need for different MCS selections.

In certain configurations, the base station 702 sends a higher layer parameter mcsTable within the SPS-Config parameter structure to configure a MCS table to be used for SPS transmissions.

Prior to transmitting the PDSCHs 732-1, 732-2, 732-3, 732-4, the base station 702 transmits a DCI 730 that contains an MCS IE (i.e., MCS indications) to indicate the MCSs to be used for transmitting the PDSCHs 732-1, 732-2, 732-3, 732-4. For example, the DCI 730 may be DCI format 1_0 or 1_1. The MCS IE serves as a pointer to a row in the configured MCS table.

If the first technique is used, the MCS IE may indicate multiple MCSs from the MCS table for multiple slot types. For example, the MCS IE may contain a first field indicating a first MCS (MCS1) to be applied to non-partitioned slots and a second field indicating a second MCS (MCS2) to be applied to partitioned slots. The MCS1 may be a higher order MCS (MCS1) configured for the non-partitioned slot. The MCS2 may be a lower order MCS configured for partitioned slots that may have potential additional cross-link interference. For example, the downlink transmissions in the DL portion 822 and the uplink transmissions in the UL portion 824 may cause interference to each other. In certain configurations, the DCI 730 may contain a MCS field that indicates the first MCS and an additional field, such as a MCS2 field, that indicates the second MCS.

If the second technique is used, the DCI 730 may contain an additional field, e.g., differentialMCS_Index, that function as the differential MCS indication as described supra.

In a second scenario, the base station 702 sends to the UE 704 a DCI 740 that schedules transmissions of repetition PDSCHs 742-1, 742-2, 742-3 in the slots 710-1 to 710-3 corresponding to the slots 810, 820-1, 820-2. Moe specifically, the repetition PDSCHs 742-1, 742-2, 742-3 are carried in the non-partitioned DL slot 810, the DL portion 822 of the partitioned DL/UL slot 820-1, and the DL portion 822 of the partitioned DL/UL slot 820-2. Each of the repetition PDSCHs 742-1, 742-2, 742-3 carries the same data.

The base station 702 can configure the UE 704 to receive the repetition PDSCHs 742-1, 742-2, 742-3 by using a higher layer parameter structure such as PDSCH-Config via RRC signaling. The PDSCH-Config parameter structure includes various parameters that define the configuration of the PDSCH, such as: resource allocation configurations (frequency domain resource allocation, resource allocation in time domain, etc.), beam management configurations, rate matching configurations, quasi co-location indicator configurations, PDSCH repetition configurations such as pdsch-AggregationFactor, and/or MCS table configuration (mcsTable).

The parameter pdsch-AggregationFactor within the PDSCH-Config parameter structure configures repetition levels of 2, 4, or 8 consecutive slots. The higher layer parameter mcsTable within the PDSCH-Config parameter structure configures the MCS table to be used for PDSCH transmission.

In one embodiment, the base station 702 defines two MCSs (MCS1 and MCS2) for PDSCH repetition based on slot type. MCS1 applies to non-partitioned slots like 810, while MCS2 applies to partitioned slots like 820-1 to 820-3. Using the first technique of the second approach described supra, the DCI 740 may include the first MCS indication indicating a first MCS to be applied to the non-partitioned DL slot 810 and a second MCS indication indicating a second MCS to be applied to the partitioned DL/UL slots 820-1, 820-2. More specifically, the DCI 740 contains a MCS IE containing a first field indicating MCS1 and a second field indicating MCS2. The DCI 740 may DCI formats 1_0 or 1_1.

Using the second technique of the second approach described supra, the DCI 740 may contain an additional field, e.g., differentialMCS_Index, that function as the differential MCS indication as described supra.

In a third scenario, the base station 702 may use Configured Grant (CG) to schedule PUSCH transmissions in multiple slots within a configured CG periodicity. That is, according to the CG configurations, in this example, the multi-slot transmissions are scheduled in a group of consecutive slots in each CG period. For example, the slots 710-1 to 710-5 and the slots 710-(i+1) to 710-(i+5) may be in two separate CG periods and carry the CG PUSCH transmissions.

In particular, in this example, the CG configurations schedule PUSCHs 752-1, 752-2, 752-3, 752-4 for transmission in each set of the slots 710-2 to 710-5, . . . , the slots 710-(i+2) to 710-(i+5), etc. More specifically, using the slots 810, 820-1, 820-2, 820-3, 830 to illustrate each group of 5 consecutive slots (e.g., the slots 710-1 to 710-5, the slots 710-(i+1) to 710-(i+5)) in the slots 710-1, . . . , 710-N, the PUSCHs 752-1, 752-2, 752-3, 752-4 are placed in the UL portions 824 of the partitioned DL/UL slots 820-1, 820-2, 820-3 and in the non-partitioned UL slot 830.

The higher layer parameter mcsTable within configuredGrantConfig parameter structure configures the MCS table to be used for CG PUSCH transmission. The base station 702 can define two MCSs for CG PUSCH transmission based on slot type, similar to the proposals described for SPS and PDSCH repetition scenarios.

In certain configurations, each MCS applies to specific sets of slots within the CG PUSCH periodicity. The slot type is considered non-partitioned if the allocation only overlaps with non-partitioned symbols, otherwise it is considered partitioned.

For Type 1 CG PUSCH, configured by higher layers, two MCSs can be provided using higher layer parameters. For example, mcsAndTBS IE within rrc-ConfiguredUplinkGrant may be used to indicate the first MCS. mscAndTBS2 IE within rrc-ConfiguredUplinkGrant may be used to indicates the second MCS.

For Type 2 CG PUSCH, configured by layer 1, the two MCSs can be provided using fields in an activation DCI (e.g., DCI 750). More specifically, a first field, Modulation and Coding Scheme, in the activation DCI indicates the first MCS. A second field, Modulation and Coding Scheme 2, indicates the second MCS.

Bitmaps can also be used to indicate which set of slots each MCS applies to, as described in other proposals.

In a fourth scenario, the base station 702 may send a DCI 760 to the UE 704 that schedules transmissions of PUSCHs 762-1, 762-2, 762-3 in the slots 710-3 to 710-5 corresponding to the slots 820-2, 820-3, 830. More specifically, the PUSCHs 762-1, 762-2, 762-3 are carried in the UL portions 824 of the partitioned DL/UL slots 820-2, 820-3 as well as the non-partitioned UL slot 830.

The base station 702 uses a higher layer parameter mcsTable within PUSCHConfig parameter structure to configure the MCS table to be used for DG PUSCH transmission.

The base station 702 can define two MCSs (MCS1 and MCS2) for DG PUSCH repetition based on slot type. MCS1 applies to non-partitioned slots such as non-partitioned UL slot 830, while MCS2 applies to partitioned slots such as the partitioned DL/UL slots 820-1, 820-2, 820-3.

Using the techniques described earlier, the base station 702 can indicate the two MCSs and the slots they apply to using layer-1 signaling in the DCI 760 or high layer signaling.

For example, the DCI 760 may include a first MCS indication for MCS1 and a second MCS indication for MCS2. More specifically, the DCI 760 contains a first field “Modulation and Coding Scheme” that indicates a first MCS (MCS1) to be applied to non-partitioned slots. The DCI 760 also contains a second field “Modulation and Coding Scheme 2” that indicates a second MCS (MC S2) to be applied to partitioned slots. The UE 704 applies MCS1 to slots such as the non-partitioned UL slot 830 and MCS2 to the partitioned DL/UL slots 820-2, 820-3 or other indication of which slots are partitioned vs non-partitioned. Alternately, the DCI 760 may contain a filed carrying a differential MCS indication instead of the second field indicating MCS2.

Bitmaps can also be signaled to indicate which slots each MCS applies to. These bitmaps can be signaled via layer-1 or high layer similar to other proposals.

This allows the UE 704 to determine different MCSs for the partitioned and non-partitioned slots when transmitting the PUSCHs 762-1, 762-2, 762-3 based on the slot type and interference levels.

In the second scenario with PDSCH repetition on PDSCHs 742-1, 742-2, 742-3 and the fourth scenario with PUSCH repetition on PUSCHs 762-1, 762-2, 762-3 described supra, the base station 702 and the UE 704 need to determine the transport block (TB) size when there are two different MCSs configured for the slots within the repetition time window.

For PUSCH/PDSCH repetition transmissions, since the repetition occurs over a smaller number of consecutive slots between 2 to 8 slots, in certain configurations, a single TB size is determined based on one MCS even when two MCSs are configured.

In certain configurations, the base station 702 and/or the UE 704 determines the single TB size for the PDSCHs 742-1, 742-2, 742-3 or the PUSCHs 762-1, 762-2, 762-3 based on the MCS configured for non-partitioned slots 810 that only overlap with non-partitioned symbols.

In certain configurations, the base station 702 and/or the UE 704 determines the single TB size for the PDSCHs 742-1, 742-2, 742-3 or the PUSCHs 762-1, 762-2, 762-3 based on the MCS configured for partitioned slots 820-1, 820-2, 820-3 that overlap with partitioned symbols.

In certain configurations, the base station 702 and/or the UE 704 determines the single TB size for the PDSCHs 742-1, 742-2, 742-3 or the PUSCHs 762-1, 762-2, 762-3 based on the first MCS configured out of the two MCSs indicated in the DCI 740 or the DCI 760 from the base station 702.

In certain configurations, the UE 704 determines the single TB size for the PDSCHs 742-1, 742-2, 742-3 or the PUSCHs 762-1, 762-2, 762-3 based on the second MCS configured out of the two MCSs indicated in the DCI 740 or the DCI 760 from the base station 702.

As such, the UE 704 use the MCS indicated in the embodiment to calculate the single transport block size for the PUSCH/PDSCH repetition transmission across the slots 710-1, . . . , 710-N even though two separate MCSs are configured.

In the first scenario with SPS transmissions such as the PDSCHs 732-1, 732-2, 732-3, 732-4 and the third scenario with CG transmissions such as the PUSCHs 752-1, 752-2, 752-3, 752-4 described supra, the base station 702 and the UE 704 need to determine the transport block (TB) size when there are two different MCSs configured for the slots 710-1, . . . , 710-N within the SPS periodicity or CG PUSCH periodicity.

Since the SPS and CG PUSCH transmissions can occur over a large number of consecutive slots, the base station 702 and the UE 704 have two options for TB size determination:

Option 1: Define a single TB size for SPS and CG PUSCH transmissions when two MCSs are configured for different slot types within the transmission periodicity.

In certain configurations, the single TB size is determined based on the MCS configured for one set of slots within the SPS/CG PUSCH periodicity. For example, the single TB size (e.g., for the PDSCHs 732-1, 732-2, 732-3, 732-4 and the PUSCHs 752-1, 752-2, 752-3, 752-4) can be determined based on the MCS configured for non-partitioned slots such as the non-partitioned DL slot 810 or the non-partitioned UL slot 830 that only overlap with non-partitioned symbols, or based on the MCS configured for partitioned slots such as the partitioned DL/UL slots 820-1, 820-2, 820-3 that overlap with partitioned symbols.

Alternatively, the single TB size can be determined based on the first or second MCS out of the two MCSs configured by the base station 702.

Option 2: Define two TB sizes for SPS and CG PUSCH transmissions when two MCSs are configured for different slot types within the transmission periodicity.

In certain configurations, each TB size is applied to specific sets of slots based on the configured MCS. For example, TB size 1 determined using MCS1 is applied to non-partitioned slots such as the non-partitioned DL slot 810 or the non-partitioned UL slot 830. TB size 2 determined using MCS2 is applied to partitioned slots such as the partitioned DL/UL slots 820-1, 820-2, 820-3.

The base station 702 can indicate the set of slots where each TB size is applied through layer-1 signaling or high layer parameters. Bitmaps can also be used as described in earlier proposals.

As such, the UE 704 can calculate different TB sizes and adapt the amount of data transmitted based on the interference levels in different slot types within the SPS or CG PUSCH periodicity.

Further, the bitmap described supra can be configured according to the techniques disclosed in U.S. Patent Application Ser. No. 63/371,107, entitled “Uplink Power Control for Dynamic TDD and Subband Full Duplex” and filed on Aug. 11, 2022, which is expressly incorporated by reference herein in its entirety.

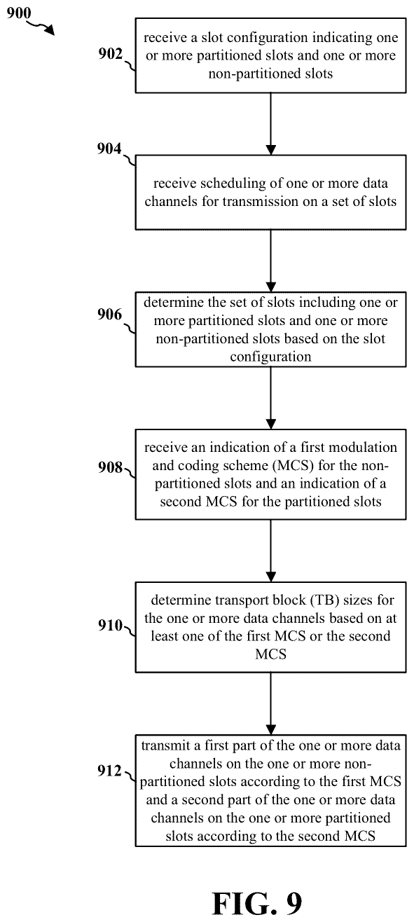

FIG. 9 is a flow chart 900 of a method (process) for transmitting one or more data channels according to multiple MCSs. The method may be performed by a UE (e.g., UE 704, the UE 250). In operation 902, the UE receives a slot configuration indicating one or more partitioned slots and one or more non-partitioned slots. In one example, the slot configuration includes a bitmap. In operation 904, the UE receives scheduling of one or more data channels for transmission on the set of slots. In one example, the one or more data channels comprise one or more of: a data channel according to a semi-persistent scheduling (SPS), repetition physical downlink shared channels (PDSCHs), a physical uplink shared channel (PUSCH) according to a configured grant (CG), and a PUSCH according to a dynamic grant (DG).

In operation 906, the UE determines a set of slots including one or more partitioned slots and one or more non-partitioned slots based on the slot configuration. In operation 908, the UE receives an indication of a first modulation and coding scheme (MCS) for the non-partitioned slots and an indication of a second MCS for the partitioned slots. More specifically, in one configuration, the UE receives a first field indicating the first MCS in downlink control information (DCI) and a second field indicating the second MCS in the DCI. In another configuration, the UE receives a first field indicating the first MCS in DCI and a differential MCS field indicating a difference between the first MCS and the second MCS. The UE determines the second MCS based on the first MCS and the differential MCS field.

In operation 910, the UE determines transport block (TB) sizes for the one or more data channels based on at least one of the first MCS or the second MCS. In one configuration, the TB size is determined based on the first MCS corresponding to the non-partitioned slots, the second MCS corresponding to the partitioned slots, a first one of the first MCS or the second MCS indicated in DCI, or a second one of the first MCS or the second MCS indicated in the DCI. In another configuration, the UE determines a first TB size for the one or more data channels based on the first MCS and determines a second TB size for the one or more data channels based on the second MCS. The first part of the one or more data channels is to be transmitted according to the first TB size on the non-partitioned slots, and the second portion of the one or more data channels is to be transmitted according to the second TB size on the partitioned slots.

In operation 912, the UE transmits a first part of the one or more data channels on the one or more non-partitioned slots according to the first MCS and a second part of the one or more data channels on the one or more partitioned slots according to the second MCS.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving scheduling of one or more data channels for transmission on a set of slots;
determining the set of slots including one or more partitioned slots and one or more non-partitioned slots;
receiving an indication of a first modulation and coding scheme (MCS) for the non-partitioned slots and an indication of a second MCS for the partitioned slots; and
transmitting a first part of the one or more data channels on the one or more non-partitioned slots according to the first MCS and a second part of the one or more data channels on the one or more partitioned slots according to the second MCS.

2. The method of claim 1, wherein receiving the indication of the first MCS and the indication of the second MCS comprises:
receiving a first field indicating the first MCS in downlink control information (DCI); and
receiving a second field indicating the second MCS in the DCI.

3. The method of claim 1, wherein receiving the indication of the first MCS and the indication of the second MCS comprises:
receiving a first field indicating the first MCS in downlink control information (DCI); and
receiving a differential MCS field indicating a difference between the first MCS and the second MCS.

4. The method of claim 3, further comprising:
determining the second MCS based on the first MCS and the differential MCS field.

5. The method of claim 1, further comprising:
receiving a slot configuration indicating the one or more partitioned slots and the one or more non-partitioned slots.

6. The method of claim 5, wherein the slot configuration comprises a bitmap.

7. The method of claim 1, wherein the one or more data channels comprise one or more of:
a data channel according to a semi-persistent scheduling (SPS),
repetition physical downlink shared channels (PDSCHs),
a physical uplink shared channel (PUSCH) according to a configured grant (CG), and
a PUSCH according to a dynamic grant (DG).

8. The method of claim 1, further comprising:
determining a transport block (TB) size for the one or more data channels based on one of the first MCS or the second MCS.

9. The method of claim 8, wherein the TB size is determined based on:
the first MCS corresponding to the non-partitioned slots;
the second MCS corresponding to the partitioned slots;
a first one of the first MCS or the second MCS indicated in downlink control information; or
a second one of the first MCS or the second MCS indicated in the DCI.

10. The method of claim 1, further comprising:
determining a first TB size for the one or more data channels based on the first MCS; and
determining a second TB size for the one or more data channels based on the second MCS.

11. The method of claim 10, wherein the first part of the one or more data channels is transmitted according to the first TB size on the non-partitioned slots, wherein the second portion of the one or more data channels is transmitted according to the second TB size on the partitioned slots.

12. An apparatus for wireless communication, the apparatus being a user equipment (UE), comprising:
a memory; and
at least one processor coupled to the memory and configured to:
receive scheduling of one or more data channels for transmission on a set of slots;
determine the set of slots including one or more partitioned slots and one or more non-partitioned slots;
receive an indication of a first modulation and coding scheme (MCS) for the non-partitioned slots and an indication of a second MCS for the partitioned slots; and
transmit a first part of the one or more data channels on the one or more non-partitioned slots according to the first MCS and a second part of the one or more data channels on the one or more partitioned slots according to the second MCS.

13. The apparatus of claim 12, wherein to receive the indication of the first MCS and the indication of the second MCS, the at least one processor is further configured to:
receive a first field indicating the first MCS in downlink control information (DCI); and
receive a second field indicating the second MCS in the DCI.

14. The apparatus of claim 12, wherein to receive the indication of the first MCS and the indication of the second MCS, the at least one processor is further configured to:
receive a first field indicating the first MCS in downlink control information (DCI); and
receive a differential MCS field indicating a difference between the first MCS and the second MCS.

15. The apparatus of claim 14, wherein to determine the second MCS based on the first MCS and the differential MCS field, the at least one processor is further configured to:
determine the second MCS based on the first MCS and the differential MCS field.

16. The apparatus of claim 12, wherein to receive a slot configuration indicating the one or more partitioned slots and the one or more non-partitioned slots, the at least one processor is further configured to:
receive a slot configuration indicating the one or more partitioned slots and the one or more non-partitioned slots.

17. The apparatus of claim 16, wherein the slot configuration comprises a bitmap.

18. The apparatus of claim 12, wherein the one or more data channels comprise one or more of:
a data channel according to a semi-persistent scheduling (SPS),
repetition physical downlink shared channels (PDSCHs),
a physical uplink shared channel (PUSCH) according to a configured grant (CG), and
a PUSCH according to a dynamic grant (DG).

19. The apparatus of claim 12, wherein to determine a transport block (TB) size for the one or more data channels based on one of the first MCS or the second MCS, the at least one processor is further configured to:
determine a transport block (TB) size for the one or more data channels based on one of the first MCS or the second MCS.

20. A computer-readable medium storing computer executable code for wireless communication of a user equipment (UE), comprising code to:
receive scheduling of one or more data channels for transmission on a set of slots;
determine the set of slots including one or more partitioned slots and one or more non-partitioned slots;
receive an indication of a first modulation and coding scheme (MCS) for the non-partitioned slots and an indication of a second MCS for the partitioned slots; and
transmit a first part of the one or more data channels on the one or more non-partitioned slots according to the first MCS and a second part of the one or more data channels on the one or more partitioned slots according to the second MCS.
